(19) United States
(12) Patent Application Publication
(10) Pub. No.: US 2026/0011518 A1
(43) Pub. Date: Jan. 8, 2026

(54) Contactor with Anti-Levitation Mechanism

(71) Applicant: TE Connectivity Solutions GmbH, Schaffhausen (CH)

(72) Inventor: Marcus PRIEST, Carpinteria, CA (US)

(73) Assignee: TE Connectivity Solutions GmbH, Schaffhausen (CH)

(21) Appl. No.: 18/764,423

(22) Filed: Jul. 5, 2024

(51) Int. Cl. H01H 50/54; H01H 50/64

(52) U.S. Cl. CPC H01H 50/546; H01H 50/641

(57) ABSTRACT

A contactor assembly having a housing defining an interior compartment. Current carrying contacts are disposed in the interior compartment of the housing. A coupling member is positioned in the interior compartment of the housing, the coupling member has conductive areas for engaging the current carrying contacts. A contact bridge extends from a first end of the coupling member to a second of the coupling member. The contact bridge has a wedge engaging opening extending therethrough. A contact bridge engaging wedge is positioned in the wedge engaging opening. An actuator assembly extends through the wedge engaging opening to spread the contact bridge engaging wedge. The actuator assembly moves the coupling member between a closed position in which the conductive areas of the coupling member engage the current carrying contacts and an open position in which the conductive areas of the coupling member are disengaged from the current carrying contacts.

### FIELD OF THE INVENTION

The invention relates generally to switches for electric circuits, and more particularly to contactor assemblies.

### BACKGROUND OF THE INVENTION

Relays and contactors are known devices used for switching of intended circuits/loads and the like. A relay is an electrically operated switch. Many known relays use an electromagnet to operate a switching mechanism mechanically, but other operating principles are also used. Relays are used where it is necessary to control a circuit by a low power signal or where several circuits must be controlled by one signal. A contactor is an electrically controlled switch used for switching a power circuit, similar to a relay except with higher current ratings.

In general, a simple electromagnetic relay consists of a coil assembly, a movable armature and one or more sets of contacts, i.e. single throw system, double throw system, etc. The sets of contact include movable contacts, fixed normally open contacts and fixed normally closed contacts. The armature is mechanically linked to one or more sets of moving contacts and is held in place by a spring.

When an electric current is passed through the coil assembly it generates a magnetic field that attracts the armature. The consequent movement of the movable contact(s) either makes or breaks (depending upon construction) a connection with a fixed contact(s). If the set of contacts was closed when the relay was de-energized, then the movement opens the contacts and breaks the connection, and vice versa if the contacts were open. When the current to the coil is switched off, the armature is returned by the spring force of the return spring toward its relaxed position. Usually this force is provided by a spring, but gravity is also used commonly in industrial motor starters. Most relays and contactors are manufactured to operate quickly. In a low-voltage application, this reduces noise; in a high voltage or current application, it reduces arcing. In order to allow the proper movement of the contacts, the spring force is designed to be less than the force generated by the coil.

However, in many contactors, contact levitation caused by electromagnetic repulsion generated by the constriction of the flow of current through the contacts can prevent or inhibit the contacts from closing properly or can cause the contact to improperly open due to a large transient pulse applied during operation. Under high current and high source voltage, contact levitation can result in unwanted arc energies that can be destructive to the contactors. Generally in such applications, a large spring force of a contact spring is provided to overcome or counteract the electromagnetic repulsion. The large spring force provides contact pressure between the movable contactor and the fixed contactor, thereby maintaining the contacts in a closed position.

In order to increase the contact pressure generated by the contact spring, the size of the spring must be increased. Consequently, the force generated by an electromagnet, which drives the movable contactor, must also be increased, requiring a larger electromagnet. This results in the size of the entire structure being increased.

It would therefore be beneficial to provide a contactor assembly in which the contacts are maintained in a closed position without the need to increase the size of the assembly. In particular, it would be beneficial to provide a contact assembly with a contact retention mechanism that holds the movable contact bridge firmly in place when closed, thereby resisting the electromagnetic repulsion of the contacts. It would also be beneficial to provide a contact retention mechanism which has minimum impact of the size and complexity of the contactor assembly.

### SUMMARY OF THE INVENTION

An embodiment is directed to a contactor assembly having a housing defining an interior compartment. Current carrying contacts are disposed in the interior compartment of the housing. A coupling member is positioned in the interior compartment of the housing, the coupling member has conductive areas for engaging the current carrying contacts. A contact bridge extends from a first end of the coupling member to a second of the coupling member. The contact bridge has a wedge engaging opening extending therethrough. A contact bridge engaging wedge is positioned in the wedge engaging opening. An actuator assembly extends through the wedge engaging opening to spread the contact bridge engaging wedge. The actuator assembly moves the coupling member between a closed position in which the conductive areas of the coupling member engage the current carrying contacts and an open position in which the conductive areas of the coupling member are disengaged from the current carrying contacts. In the closed position the wedge spreader engages the wedge, locking the bridge contact in the closed position.

The wedge engaging opening may have a tapered side wall which has a larger diameter proximate a first surface and tapers inward to a smaller diameter. The contact bridge engaging wedge may have angled sections which are configured to engage the tapered side wall of the wedge engaging opening of the contact bridge. A clip may be provided proximate an end of an armature of the actuator assembly. The armature extends through the wedge engaging opening of the contact bridge, an armature receiving opening of the contact bridge engaging wedge, and an opening of the clip. The contact bridge engaging wedge is positioned in the wedge engaging opening of the contact bridge. Ends of the angled sections of the contact bridge engaging wedge have a diameter which is larger than the larger diameter of the wedge engaging opening of the contact bridge, wherein the contact bridge is prevented from moving past the ends of the angled sections of the engagement arms of the contact bridge engaging wedge. With the actuator assembly and the coupling member in the closed position, the angled sections of the contact bridge engaging wedge are forced outward by the wedge spreader, causing the angled sections of the contact bridge engaging wedge to engage the angled sections of the causing the angled sections of the contact bridge engaging wedge to engage angled sections of the wedge engaging opening of the contact bridge, thereby locking the contact bridge in the closed position. This allows the a much higher locking force to be provided by the closed armature, rather than a lower locking force provided by the contact spring.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative contactor assembly.

FIG. 2 is a cross-sectional view of the contactor assembly along line 2-2 shown in FIG. 1, illustrating the contacts of the contactor assembly in an open position.

FIG. 3 is a cross-sectional view of the contactor assembly, similar to that shown in FIG. 2, illustrating the contacts of the contactor assembly in a closed position.

FIG. 4 is an enlarged perspective view of a contact bridge engaging wedge shown in FIG. 2.

FIG. 5 is an enlarged plan view of the contact bridge engaging wedge of FIG. 4.

FIG. 6 is an enlarged perspective view of the contact bridge or coupling member of FIG. 2.

FIG. 7 is a cross sectional view of the contact bridge or coupling member of FIG. 6, taken along a longitudinal axis of the contact bridge or coupling member.

FIG. 8 is an enlarged perspective view of a clip which is positioned on the contact bridge engaging wedge.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

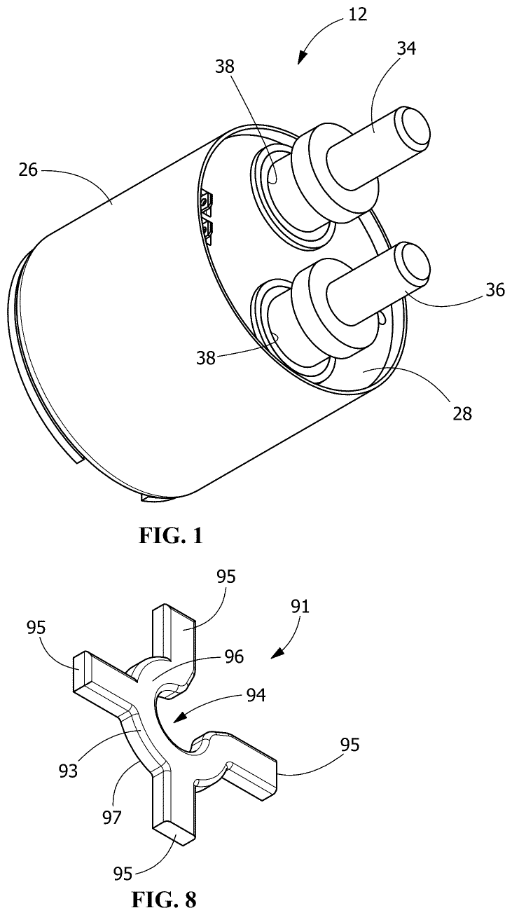

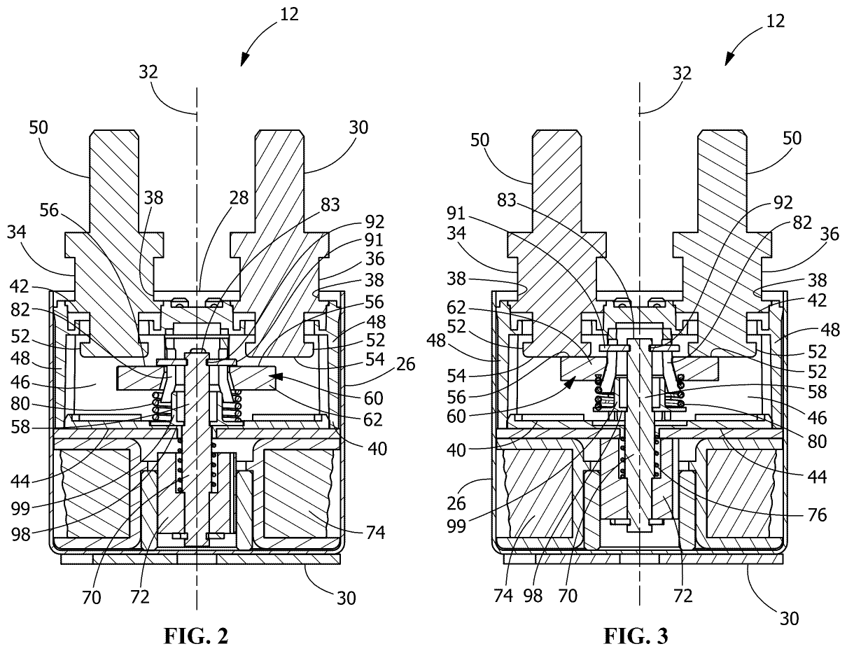

The illustrative contactor assembly 12 shown in FIG. 1 includes an outer housing 26 that extends between opposite ends 28, 30 along a longitudinal axis 32. While the outer housing 26 is shown in the approximate shape of a cylindrical can, alternatively the outer housing 26 may have a different shape. The outer housing 26 may include, or be formed from, a dielectric material such as one or more polymers. In another embodiment, the outer housing 26 may include or be formed from conductive materials, such as one or more metal alloys. As shown FIGS. 2 and 3, and as described below, the contactor assembly 12 includes a set of fixed current carrying contacts 34, 36 (shown in FIG. 2) that convey current through the contactor assembly 12. The contacts 34, 36 close and open an electric circuit (not shown).

The end 28 of the housing 26 includes several openings 38 through which the contacts 34, 36 extend. The contacts 34, 36 extend through the openings 38 to mate with conductive bodies that are joined with the electrical circuit such as, but not limited to, bus bars (not shown).

Referring to FIGS. 2 and 3, the contactor assembly 12 includes an inner housing 40 disposed within the outer housing 26. The inner housing 40 may extend between opposite ends 42, 44. The contacts 34, 36 protrude through the end 42 of the inner housing 40 to be presented at the end 28 of the outer housing 26. The inner housing 40 may include, or be formed from, a dielectric material such as one or more polymers. The inner housing 40 includes an interior chamber or compartment 46.

The contacts 34, 36 are disposed in the interior compartment 46. The interior compartment 46 may be sealed and loaded with an inert and/or insulating gas, such as, but not limited to, sulphur hexafluoride, nitrogen and the like. The interior compartment 46 is sealed so that any electric arc extending from the contacts 34, 36 are contained within the interior compartment 46 and do not extend out of the interior compartment 46 to damage other components of the contactor assembly 12.

In the illustrated embodiment, permanent magnets 48 are provided on opposite sides of the interior compartment 46. Alternatively, the magnets 48 may be electromagnets or other source of a magnetic flux.

The contactor assembly 12 shown and described herein is provided for illustrative purposes. The configuration of the contactor assembly 12 and its components may vary without departing from the scope of the invention.

As shown in FIGS. 2 and 3, the contacts 34, 36 are elongated bodies that extend between mating ends 50 and engagement ends 52. The mating ends 50 couple with the electrical circuit to electrically couple the contactor assembly 12 with the electrical circuit. In the illustrated embodiment, the engagement ends 52 include conductive pads 54. The conductive pads 54 include, or are formed from, a conductive material such as, but not limited to, one or more metals or metal alloys. For example, the conductive pads 54 may be formed from a silver (Ag) alloy. The use of a silver alloy may prevent the conductive pads 54 from welding to conductive areas 56 of an actuator subassembly 58. Alternatively, the conductive pads 54 may be made from softer material, such as, but not limited to, copper or copper alloys, as will be more fully described.

In the illustrative embodiment shown, the actuator subassembly 58 moves along or in directions parallel to the longitudinal axis 32 to electrically couple contacts 34, 36 with one another. The actuator assembly 58 includes a coupling member 60 on which the conductive areas 56 are positioned.

The coupling member 60 has a contact bridge 62 with the conductive areas 56 positioned at either end. The conductive areas 56 of the contact bridge 62 are placed in physical and electrical contact with the conductive pads 56 when the coupling member 60 and the actuator assembly 58 is moved to the closed position. A wedge engaging opening 64 is provided in the center of the contact bridge 64. As shown in FIG. 7, the wedge engaging opening 64 has a tapered side wall 66 which has a larger diameter D1 proximate a first or lower surface 68 and tapers inward to a smaller diameter D2.

The contact bridge 62 includes, or is formed from, a conductive material such as, but not limited to, one or more metals or metal alloys. The conductive areas 56 may be formed of the same material as the contact bridge 62 or may be formed from other conductive materials. For example, the conductive areas 56 may be formed from a silver (Ag) alloy. The use of a silver alloy may prevent the conductive areas 56 from welding to conductive pads 54. Alternatively, the conductive areas 56 may be made from softer material than that of the contact bridge 62, such as, but not limited to, copper or copper alloys.

The actuator subassembly 58 includes an armature or magnetized body 72 coupled to an elongated shaft 70. The armature 72 may include a permanent magnet that generates a magnetic field or flux oriented along the longitudinal axis 32. The contactor assembly 12 includes a coil body 74 that encircles the armature 72. The coil body 74 may be used as an electromagnet to drive the armature 72 and the shaft 70 along the longitudinal axis 32. For example, the coil body 74 may include conductive wires or other components that encircle the armature 72. An electric current may be applied to the coil body 74 to create a magnetic field that is oriented along the longitudinal axis 32. Depending on the direction of the current passing through the coil body 74, the magnetic field induced by the coil body 74 may have magnetic north oriented upward toward the end 28 of the outer housing 26 or downward toward the end 30. In either polarity, the attractive force will always move the armature assembly and bridge contact to the closed position.

An armature spring 76 is positioned proximate the magnetized armature 72. A contact spring 80 is positioned in the interior compartment 46. The armature spring 76 and the contact spring 80 cooperate with the armature 72 and shaft 70 to facilitate the movement of the armature 72 and shaft 70 and the coupling member 60 between the open and closed positions.

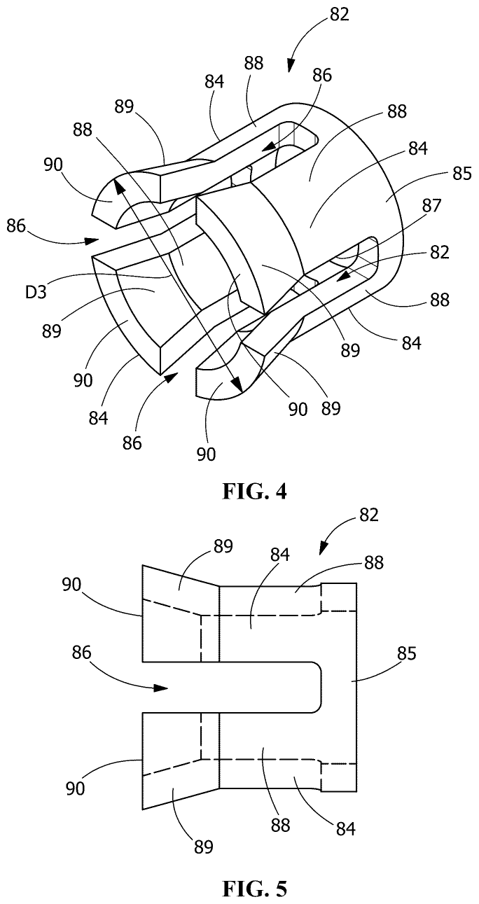

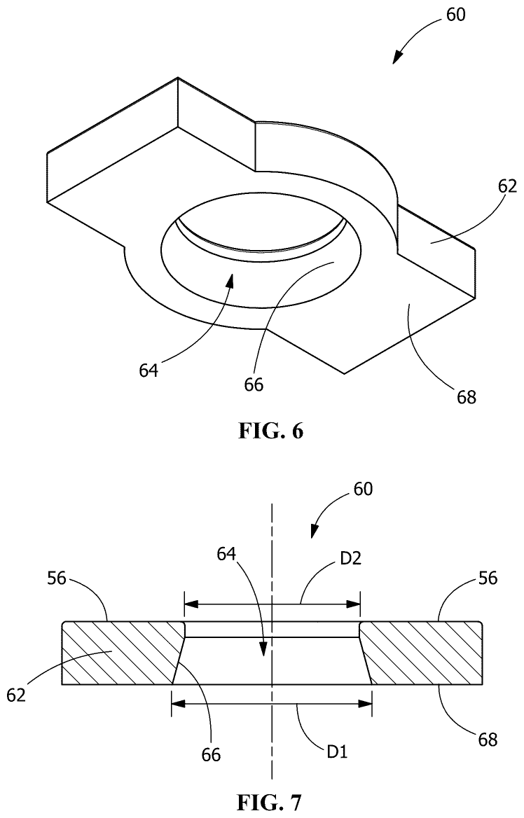

A contact bridge engaging wedge 82 is positioned proximate end 83 of the shaft 70. As shown in FIGS. 4 and 5, the contact bridge engaging wedge 82 has engagement arms 84 which extend from a base 85. In the illustrative embodiment shown, the four engagement arms 84 are spaced around the circumference of the base 85, although other embodiments may be used. An armature receiving opening 87 is provided in the base 85.

The engagement arms 84 are spaced apart by slots 86, allowing the engagement arms to move independently of each other. The engagement arms have straight sections 88 which extend from the base 85. Angled sections 89 extend from the straight sections 88. The angled sections 89 are provided proximate free ends 90 of the engagement arms 84.

A clip 91 is provided proximate the end 83 of the shaft 70. As shown in FIGS. 2 and 3, the clip 91 is received in a recess 92 of the shaft 70 to retain the clip 91 in position relative to the shaft 70. In the illustrative embodiment shown in FIG. 8, the clip has an armature mounting section 93 with an opening 94 which is dimensioned to receive the shaft 70. The armature mounting section 93 is dimensioned to be received and retained in the recess 92.

Engagement arms 95 extend outward from the armature mounting section 93. In the illustrative embodiment shown, four engagement arms 95 are provided and extend through the slots 86 of the contact bridge engaging wedge 82. However, other configurations may be used which are tailored to the configuration of the contact bridge engaging wedge 82. A top surface 96 of the clip 91 is configured to engage the base 85 of the contact bridge engaging wedge 82. A bottom surface 97 of the clip 91 is configured to engage the contact bridge 62 of the coupling member 60.

A wedge spreader 98 is provided is provided proximate to, but spaced from the end 83 of the shaft 70. The wedge spreader has a circumferentially extending arm 99 which extends in a plane which is essentially parallel to the longitudinal axis 32 of the shaft 70. In other embodiments, the arm 99 may be one or more arms which are spaced about the wedge spreader 98. The wedge spreader 98 is movable between a first position, in which the arm 99 is spaced from the contact bridge engaging wedge 82, and a second position in which that arm 99 engages the angled sections 89 of the contact bridge engaging wedge 82.

As shown in FIGS. 2 and 3, the shaft 70 of the actuator subassembly 58 is oriented along the longitudinal axis 32. The end 83 of the shaft 70 extends through the wedge engaging opening 64 of the contact bridge 62, the armature receiving opening 87 of the contact bridge engaging wedge 82, and the opening 94 of the armature mounting section 93 of the clip 91.

The contact bridge engaging wedge 82 is positioned in the wedge engaging opening 64 of the contact bridge 62. Ends of the angled sections 89 of the engagement arms 84 of the contact bridge engaging wedge 82 have a diameter D3 (FIG. 4) which is larger than the diameter D1 (FIG. 7) of the wedge engaging opening 64 of the contact bridge 62. This configuration prevents the contact bridge 62 from moving downward (as shown in FIGS. 2 and 3) past the ends of the angled sections 89 of the engagement arms 84 of the contact bridge engaging wedge 82.

As previously stated, the clip 91 is provided proximate the end 83 of the shaft 70 and is received in a recess 92 of the shaft 70 to retain the clip 91 in position relative to the shaft 70. In this position, the engagement arms 95 of the clip 91 extend through the slots 86 of the contact bridge engaging wedge 82. The contact bridge 62 of the coupling member 60 is movably retained on the shaft 70 between the angled sections 89 of the engagement arms 84 of the contact bridge engaging wedge 82 and the clip 91.

In use, as shown in FIGS. 2 and 3, the actuator subassembly 58 moves in opposing directions along the longitudinal axis 32 to move the coupling member 60 toward the contacts 34, 36 (closed position, FIG. 3) and away from the contacts 34, 36 (open position, FIG. 2). For example, the actuator subassembly 58 may move toward the engagement ends 52 of the contacts 34, 36 to lift the coupling member 60 toward the engagement ends 52.

The mating of the conductive areas 56 of the coupling member 60 with the conductive pads 54 of the contacts 34, 36 causes the current to flow across the coupling member 60 of the actuator subassembly 58, thereby closing the electrical circuit. In the illustrated embodiment, the conductive areas 56 and the coupling member 60 electrically joins the contacts 34, 36 with one another such that current may flow through the conductive pads 54 of the contacts 34, 36, through the conductive pads 56 and across the contact bridge 62 of the coupling member 60. The current may flow in either direction.

As shown in FIG. 2, the contactor assembly 12 is in an open state, as the coupling member 60 of the actuator subassembly 58 is decoupled from contacts 34, 36. In this position, the coupling members 60 does not interconnect or electrically connect the contacts 34, 36 with one another. As a result, current cannot pass across the contacts 34, 36. In this position, the contact bridge 62 is positioned between the angled sections 89 of the engagement arms 84 of the contact bridge engaging wedge 82 and the clip 91. In the open position, the contact bridge 62 can move relative to the actuator subassembly 58 between the between the angled sections 89 of the engagement arms 84 of the contact bridge engaging wedge 82 and the clip 91.

In order to drive the actuator subassembly 58 toward the contacts 34, 36, the coil body 74 is energized to create a magnetic field along the longitudinal axis 32. The magnetic field causes the armature 72 of the actuator assembly 58 toward the contacts 34, 36 along the longitudinal axis 32. In the illustrated embodiment, a armature spring 76 exerts a force on the shaft 70 in a downward direction toward the end 30 of the outer housing 26. The force exerted by the armature spring 76 prevents the actuator subassembly 58 from moving toward and mating with the contacts 34, 36 without the creation of a magnetic field by the coil body 74. The magnetic field generated by the coil body 74 is sufficiently large or strong so as to overcome the force exerted on the armature 72 by the armature spring 76 and drive the armature 72, the shaft 70, the wedge spreader 98 and the actuator subassembly 58 toward the contacts 34, 36.

FIG. 3 is a cross-sectional view of the contactor assembly 12 in a closed state in accordance with one embodiment of the present disclosure. In the closed state, the actuator subassembly 58 has moved within the contactor assembly 12 along the longitudinal axis 32 sufficiently far that the conductive areas 56 of the contact bridge 62 of the coupling member 60 are mated with conductive pads 54 of the contacts 34, 36. As a result, the actuator subassembly 58 has electrically coupled contacts 34, 36 to close the electrical circuit. In the closed position, the current flows, through the contact 34 across the contact bridge 62 to the contact 36 (or alternatively, through the contact 36 across the contact bridge 62 to the contact 34).

As the actuator assembly 58 is moved toward the closed position, the conductive areas 50 of the contact bridge 62 engage the conductive pads 54 of the contacts 34, 36. As this occurs, the contact bridge 62 is prevented from further upward (as shown in FIG. 3) movement. However, the shaft 70 of the armature subassembly 58 continues until the top of the armature 72 engages the top core 40. As this motion of the armature 72 continues, the engagement arms 95 of the clip 91 cooperate with the contact bridge engaging wedge 82 to move the contact bridge engaging wedge 82 relative to the contact bridge 62. The continued movement of the contact bridge wedge spreader 98 the arm 99 of the wedge spreader to engage the angled sections 89 of the contact bridge engaging wedge 82, forcing the angled sections 89 of the contact bridge engaging wedge 82 to engage the tapered side wall 66 of the wedge engaging opening 64 of the contact bridge 62, as shown in FIG. 3. As the diameter D3 of the angled sections 89 is greater than the diameter D1 proximate a lower surface 68 of the contact bridge 62, the angled sections 89 of the contact bridge engaging wedge 82 lock the contact bridge 62 in place (as viewed in FIG. 3). The outward mechanical force provides a retention force which maintains the contact areas 56 of the contact bridge 62 in mechanical and electrical engagement with the contact pads 54 of the contacts 34, 36. The contact force provided by the contact bridge engaging wedge 82 results in a contact force equal to the armature closed force which exceeds a typical contact spring force of 5 to 10 lbs. by an order of magnitude.

The interaction of the contact bridge engaging wedge 82 with the contact bridge 62 when the contactor assembly 12 is in the closed position, reduces or eliminates the conductive areas 56 from being pushed away or bounced from the conductive pads 54, 56 as This allows for a much more reliable and effective electrical connection to occur between the conductive areas 56 and the conductive pads 54, 56, thereby reducing the opportunity for arcing to occur across the conductive pads.

In addition, if a large transient pulse current or other large current is applied across the conductive pads 54 and the conductive areas 56 during operation, the increased repulsion force between the conductive pads 54 and the conductive areas 56 will be counteracted by the high mechanical contact force, thereby maintaining the conductive pads 54 and the conductive areas 56 in physical and electrical contact during operation, thereby preventing unwanted movement or levitation of the conductive areas 56 and the contact bridge 62 relative to the conductive pads, which in turn prevents unwanted arcing between the conductive pads 54 and the conductive areas 56.

As the levitation, bouncing, separation and arcing between the conductive pads 54 and the conductive areas 56 is controlled, the contactor assembly 12 can conduct high transient currents at high voltage potential without fear of the destruction of the device due to contact levitation.

While the contact bridge 62 and the contact bridge engaging wedge 82 are shown in use with the illustrative contactor assembly 12, the contact bridge 62 and the contact bridge engaging wedge 82 and the generation of a large mechanical contact force to minimize levitation, bouncing, separation and arcing of the contact pads 54 and contact areas 56 can be used in many different applications and with many different type of electrical connectors in which contacts are moved between an open and a closed position.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A contactor assembly comprising:
a housing defining an interior compartment;
current carrying contacts disposed in the interior compartment of the housing;
a coupling member, the coupling member having conductive areas for engaging the current carrying contacts, a contact bridge extends from a first end of the coupling member to a second of the coupling member, the contact bridge having a wedge engaging opening extending therethrough;
a contact bridge engaging wedge positioned in the wedge engaging opening;
an actuator assembly extends through the wedge engaging opening to spread the contact bridge engaging wedge, the actuator assembly moves the coupling member between a closed position in which the conductive areas of the coupling member engage the current carrying contacts and an open position in which the conductive areas of the coupling member are disengaged from the current carrying contacts.

2. The contactor assembly as recited in claim 1, wherein the wedge engaging opening has a tapered side wall which has a larger diameter proximate a first surface and tapers inward to a smaller diameter.

3. The contactor assembly as recited in claim 2, wherein the contact bridge engaging wedge has angled sections which are configured to engage the tapered side wall of the wedge engaging opening of the contact bridge.

4. The contactor assembly as recited in claim 3, wherein a clip is provided proximate an end of an armature of the actuator assembly.

5. The contactor assembly as recited in claim 4, wherein the armature extends through the wedge engaging opening of the contact bridge, an armature receiving opening of the contact bridge engaging wedge, and an opening of the clip.

6. The contactor assembly as recited in claim 5, wherein the contact bridge engaging wedge is positioned in the wedge engaging opening of the contact bridge, ends of the angled sections of the contact bridge engaging wedge have a diameter which is larger than the larger diameter of the wedge engaging opening of the contact bridge, wherein the contact bridge is prevented from moving past the ends of the angled sections of the engagement arms of the contact bridge engaging wedge.

7. The contactor assembly as recited in claim 6, wherein with the actuator assembly and the coupling member in the closed position, the angled sections of the contact bridge engaging wedge exert a high contact force on the contact bridge to provide a retention force which maintains the contact areas of the contact bridge in mechanical and electrical engagement with the current carrying contacts.

8. The contactor assembly as recited in claim 1, wherein a wedge spreader is provided proximate to, but spaced from an end of a shaft of the actuator assembly, the wedge spreader being movable between a first position and a second position.

9. The contactor assembly as recited in claim 8, wherein with the actuator assembly and the coupling member in the closed position, angled sections of the contact bridge engaging wedge are forced outward by the wedge spreader, causing the angled sections of the contact bridge engaging wedge to engage angled sections of the wedge engaging opening of the contact bridge, locking the contact bridge in the closed position.

10. The contactor assembly as recited in claim 1, wherein the contact bridge engaging wedge is positioned proximate an end of a shaft of the actuator assembly.

11. The contactor assembly as recited in claim 1, wherein the contact bridge engaging wedge has engagement arms which extend from a base of the contact bridge engaging wedge.

12. The contactor assembly as recited in claim 11, wherein an armature receiving opening extends through the base of the contact bridge engaging wedge.

13. The contactor assembly as recited in claim 12, wherein the engagement arms are spaced around a circumference of the base of the contact bridge engaging wedge.

14. The contactor assembly as recited in claim 11, wherein the engagement arms are spaced apart by slots, allowing the engagement arms to move independently of each other.

15. The contactor assembly as recited in claim 14, wherein the engagement arms have straight sections which extend from the base and angled sections which extend from the straight sections, the angled sections are provided proximate free ends of the engagement arms.

16. The contactor assembly as recited in claim 1, wherein a clip is provided proximate an end of a shaft of the actuator assembly.

17. The contactor assembly as recited in claim 15, wherein the clip is received in a recess of the shaft to retain the clip in position relative to the armature.

18. The contactor assembly as recited in claim 16, wherein the clip has an armature mounting section with an opening which is dimensioned to receive the shaft, the armature mounting section is dimensioned to be received and retained in the recess.

19. The contactor assembly as recited in claim 17, wherein engagement arms extend outward from the armature mounting section, the engagement arms extend through slots provided in the contact bridge engaging wedge.

20. The contactor assembly as recited in claim 18, wherein a top surface of the clip is configured to engage the contact bridge engaging wedge and a bottom surface of the clip is configured to engage the contact bridge of the coupling member.
